(19) United States
(12) Patent Application Publication
(10) Pub. No.: US 2015/0316491 A1
(43) Pub. Date: Nov. 5, 2015

(54) SIMULATED BIOLOGICAL MATERIAL FOR PHOTOACOUSTIC DIAGNOSTIC APPARATUS AND METHOD FOR MANUFACTURING THE SAME

(71) Applicant: CANON KABUSHIKI KAISHA, Tokyo (JP)

(72) Inventor: Shintetsu Go, Yokohama-shi (JP)

(21) Appl. No.: 14/701,353

(22) Filed: Apr. 30, 2015

(30) Foreign Application Priority Data
May 2, 2014 (JP) 2014-095155

(51) Int. Cl. G01N 21/93; C08L 75/12; C08L 83/04; G01N 29/06; C08K 3/22

(52) U.S. Cl. CPC G01N 21/93; G01N 29/0681; C08K 3/22; C08L 83/04; C08L 75/12; C08K 2003/2241

(57) ABSTRACT

A simulated biological material for photoacoustic diagnostic apparatus contains a polyol or a cured material produced from a polyol and a polyisocyanate, and titanium oxide fine particles in the polyol or the cured material. The titanium oxide fine particles are surface-treated with a polysiloxane having a Si—H partial structure.

### BACKGROUND OF THE INVENTION

1. Field of the Invention

The present application relates to a simulated biological material (tissue_mimicking_material) used for quality control and calibration of photoacoustic diagnostic apparatuses, specifically to a simulated biological material having stable light scattering characteristics, and to a method for manufacturing the simulated biological material.

2. Description of the Related Art

A photoacoustic diagnostic apparatus is an apparatus intended to visualize morphologic information and functional information in living tissue according to detected signals of acoustic waves (typically ultrasonic waves) generated from an absorbent in the living tissue, such as hemoglobin or glucose. The acoustic waves are generated by thermal expansion of the absorbent or the living tissue around the absorbent caused by irradiating the absorbent with light. Photoacoustic diagnostic apparatuses are expected to be applied to medical practice such as early diagnosis of cancer.

For the quality control and calibration of photoacoustic diagnostic apparatuses, as well as for those of known ultrasonic diagnostic apparatuses and X-ray diagnostic apparatuses, simulated biological materials are used as reference materials. For highly accurate, stable quality control and calibration of a photoacoustic diagnostic apparatus, accordingly, it is desirable that the simulated biological material have stable photoacoustic characteristics equivalent to living tissue and having small and few fluctuations. Fluctuations of the photoacoustic characteristics of a simulated biological material can result from dispersion in properties caused by changes in the external environment, such as temperature and humidity, deterioration in material caused by repeated use, or variations in the manufacturing process resulting from the raw materials and the manufacturing method. In order to achieve a stable simulated biological material having less fluctuating photoacoustic characteristics, it is important to select a formulation of materials that are environmentally stable, durable, and less variable in the manufacturing process, and a stable manufacturing process.

In known optical or photoacoustic diagnostic apparatuses, fillers are used for controlling the scattering coefficient of the simulated biological material. The filler may be an inorganic fine particulate, such as titanium oxide particles, aluminum oxide particles, or silica particles, or an organic fine particulate, such as polystyrene particles or polyethylene particles. A solid or liquid material dispersed in water or a polymer, such as urethane resin or acrylic resin, has been devised as a simulated biological material containing inorganic fine particles or organic fine particles.

For example, Japanese Patent Laid-Open No. 2-128750 discloses a simulated biological material for optical diagnostic apparatuses, using polyethylene particles having different diameters as the filler for controlling the scattering coefficient. In this simulated biological material, the polystyrene particles are dispersed in water. Also, Japanese Patent Laid-Open No. 2011-209691 discloses a simulated biological material for photoacoustic diagnostic apparatuses, using titanium oxide fine particles surface-treated with aluminum oxide and hexamethyldisilazane as the filler for controlling the scattering coefficient. In this simulated biological material, the titanium oxide fine particles are dispersed in a polyurethane resin.

The simulated biological material disclosed in the above-cited Japanese Patent Laid-Open No. 2-128750 is a liquid composite material of water and polystyrene particles dispersed in the water. This simulated biological material can simulate the scattering coefficient of living tissue by controlling the particle size or content of the polystyrene particles. It is however difficult for the simulated biological material to simulate a wide range of acoustic properties, such as acoustic velocity and attenuation coefficient, of living tissue.

The simulated biological material disclosed in Japanese Patent Laid-Open No. 2011-209691 contains titanium oxide fine particles that are surface-treated with aluminum oxide and hexamethyldisilazane for increasing the dispersibility in the urethane resin. The titanium oxide fine particles surface-treated with aluminum oxide and hexamethyldisilazane are however not sufficiently compatible with polyol that is a raw material of the urethane resin. Accordingly, the titanium oxide fine particles aggregate or form a sediment in the polyol, consequently degrading the dispersibility and stability thereof in the urethane resin that is a cured material produced from polyol and polyisocyanate.

### SUMMARY OF THE INVENTION

Accordingly, aspects of the present application provide a simulated biological material having stable light scattering characteristics with high repeatability for photoacoustic diagnostic apparatuses, and a method for manufacturing the simulated biological material.

The simulated biological material (tissue_mimicking_material) for photoacoustic diagnostic apparatuses according to an aspect of the application contains a polyol, and titanium oxide fine particles in the polyol. The titanium oxide fine particles are surface-treated with a polysiloxane having a Si—H partial structure.

The simulated biological material (tissue_mimicking_material) for photoacoustic diagnostic apparatuses according to another aspect of the application contains a urethane resin that is a cured material produced from a polyol and a polyisocyanate, and titanium oxide fine particles in the urethane resin. The titanium oxide fine particles are surface-treated with a polysiloxane having a Si—H partial structure.

Further features of the present invention will become apparent from the following description of exemplary embodiments with reference to the attached drawings.

### DESCRIPTION OF THE EMBODIMENTS

Although the tissue_mimicking_material (hereinafter referred to as simulated biological material) for photoacoustic diagnostic apparatuses of an embodiment contains a polyol and titanium oxide fine particles in the polyol, a urethane resin that is a cured material produced from the polyol and a polyisocyanate may be used instead of the polyol. In other words, the simulated biological material may contain a urethane resin and titanium oxide fine particles in the urethane resin. The titanium oxide fine particles are surface-treated with a polysiloxane having a Si—H partial structure.

### Simulated Biological Material for Photoacoustic Diagnostics

An embodiment of the present application will now be described. The components of the simulated biological material for photoacoustic diagnostics will first be described.

### (1) Titanium Oxide Fine Particles

The titanium oxide fine particles used in the simulated biological material of the present embodiment may be crystalline titanium oxide fine particles having a crystal structure of a rutile form (tetragonal system), an anatase form (tetragonal system), or a brookite form (rhombic system), or amorphous titanium oxide fine particles. Crystalline titanium oxide fine particles having a rutile-type tetragonal crystal structure are advantageous, which have a high refractive index and relatively low photocatalytic activity. The surfaces of the titanium oxide fine particles of the present embodiment may be coated with an inert inorganic material, such as aluminum oxide or silicon oxide, so as to reduce the photocatalytic activity thereof or increase the dispersibility thereof in a medium such as resin.

The titanium oxide fine particles have a primary particle size in the ranger of 5 nm to 1 μm, preferably in the range of 10 nm to 300 nm. The particle size is selected within the range in which the particles exhibit a desired scattering coefficient and do not significantly affect acoustic properties, such as acoustic velocity and attenuation coefficient. The content of the titanium oxide fine particles in the dispersion medium, such as urethane resin, is 0.01% by weight to 1.0% by weight, preferably 0.05% by weight to 0.50% by weight, relative to the total weight of the constituents, and is appropriately set within the range in which the particles do not significantly affect acoustic properties, such as acoustic velocity and attenuation coefficient.

The titanium oxide fine particles are surface-treated with a polysiloxane as below.

### (2) Polysiloxane

The molecule of the polysiloxane used for the surface treatment of the titanium oxide fine particles has a Si—H partial structure. The number of the Si—H partial structures in the molecule is not particularly limited, and the polysiloxane having at least one Si—H partial structure in the molecule can be effective in the embodiment. The reason of this is as below: The Si—H partial structure reacts with the hydroxy groups (—OH) present at the surfaces of the titanium oxide fine particles to form linkages between the polysiloxane and the titanium oxide particles. This reaction occurs even though only one Si—H partial structure is present in the molecule. A polysiloxane having at least one Si—H partial structure can therefore be used for coating the surfaces of the titanium oxide fine particles. However, as the number of Si—H partial structures in the polysiloxane molecule increases, the Si—H partial structures have more chances of reacting with the hydroxy groups at the surfaces of the titanium oxide fine particles and accordingly more firmly coat the surfaces of the titanium oxide fine particles.

The Si—H partial structure may lie at any position in the polysiloxane molecule without particular limitation.

Examples of the polysiloxane used in the present embodiment include what is called straight silicone oil, such as dimethylpolysiloxane, methylphenylpolysiloxane, and methylhydrogenpolysiloxane; reactive modified polysiloxanes having a reactive substituent, such as amino, epoxy, or carboxy, at the side chain and/or the terminal, at least in part, thereof; and nonreactive modified polysiloxanes having an nonreactive substituent, such as alkyl, fluoroalkyl, aralkyl, ester, or ether. Advantageous polysiloxanes are alkylhydrogenpolysiloxanes having an active hydrogen (Si—H) that can forming a chemical bond by a reaction with the hydroxy group at the surfaces of the titanium oxide fine particles. Alkylhydrogenpolysiloxanes are compatible with polyols. From the viewpoint of compatibility with polyols, methylhydrogenpolysiloxane, ethylhydrogenpolysiloxane, and propylhydrogenpolysiloxane are more advantageous, and methylhydrogenpolysiloxane is particularly advantageous.

The amount of the polysiloxane coating the titanium oxide particles may be 0.1% by weight to 50% by weight, such as 0.1% by weight to 10% by weight, relative to the weight of the titanium oxide, and is set within the range in which the acoustic properties, such as acoustic velocity and attenuation coefficient, are not affected.

The surface treatment of the titanium oxide fine particles with the polysiloxane may be performed in a wet process in which a mixture prepared by adding titanium oxide fine particles and polysiloxane to water or an organic solvent is stirred or agitated with a stirrer or mixer, such as a mechanical stirrer or a ball mill. Alternatively, a dry process may be used for the surface treatment. In this instance, a mixture of the titanium oxide fine particles and polysiloxane is stirred or agitated with a stirrer or mixer, such as a ball mill or a jet mill, without using a solvent. The surface treatment is however not limited to these processes.

### (3) Dispersion Medium (Polyol or Urethane Resin)

In an embodiment, a urethane resin may be used as the dispersion medium of the titanium oxide fine particles. The urethane resin is a polymer having urethane linkages formed by condensation of the hydroxy group of a polyol and the isocyanate group of a polyisocyanate. In another embodiment, polyol, which is one of the precursors of urethane resin in urethane resin synthesis, may be used as the dispersion medium of the titanium oxide fine particles.

Examples of the polyol used as the raw material of the urethane rein and as the dispersion medium of the titanium oxide fine particles include polyester polyol, polyether polyol, and polyacrylic polyol. These polyols may be used singly or in combination.

Polyester polyol can be produced by, for example, a reaction of a polybasic acid and a polyol. Exemplary polybasic acids include o-phthalic acid, isophtalic acid, terephthalic acid, 1,4-naphthalenedicarboxylic acid, and 2,5-naphthalenedicarboxylic acid. Exemplary polyols include ethylene glycol, 1,2-propanediol, 1,3-propanediol, 1,3-butanediol, and 1,4-butanediol.

Polyether polyol can be produced by, for example, adding an alkylene dioxide to a polyhydric alcohol by ring-opening polymerization. Examples of the polyhydric alcohol include ethylene glycol, diethylene glycol, propylene glycol, dipropylene glycol, and glycerol. Examples of the alkylene oxide include ethylene oxide, propylene oxide, butylene oxide, styrene oxide, and tetrahydrofuran.

Polyacrylic polyol can be produced by, for example, copolymerization of a (meth)acrylic ester and a monomer having a hydroxy group. Examples of the (meth)acrylic ester include methyl (meth)acrylate, butyl (meth)acrylate, 2-ethylhexyl (meth)acrylate, and cyclohexyl (meth)acrylate. Monomers having a hydroxy group include 2-hydroxyethyl (meth)acrylate, 2-hydroxypropyl (meth)acrylate, 3-hydroxypropyl (meth)acrylate, 2-hydroxybutyl (meth)acrylate, and 4-hydroxybutyl (meth) acrylate.

Polyisocyanates used as a raw material of the urethane include, aliphatic polyisocyanates, such as trimethylene diisocyanate, tetramethylene diisocyanate, 1,2-propylene diisocyanate, and 1,6-diisocyanato-3-isocyanatomethylhexane; alicyclic polyisocyanates, such as 1,3-cyclohexane diisocyanate, 3-isocyanatomethyl-3,5,5-trimethylcyclohexyl isocyanate, and 1,3,5-triisocyanatocyclohexane; and aromatic aliphatic triisocyanates, such as p-phenylene diisocyanate, 4,4′-diphenyl diisocyanate, 2,4-tolylene diisocyanate, triphenylmethane-4,4′,4″-triisocyanate, 1,3,5-triisocyanatobenzene, and 2,4,6-triisocyanatotoluene. These polyisocyanates may be used singly or in combination.

In an embodiment, a curable composition containing titanium oxide fine particles uniformly dispersed in polyol is prepared. In this operation, an appropriate amount of catalyst may be added for promoting the condensation reaction of the hydroxy group of the polyol and the isocyanate group of the polyisocyanate. Examples of the catalyst include organic metal compounds, such as dibutyltin dilaurate, dibutyltin diacetate, and dioctyltin dilaurate; and organic amines, such as triethylenediamine and triethylamine, and salts thereof.

When the curable composition containing titanium oxide fine particles uniformly dispersed in polyol is prepared, additives, such as a plasticizer and a release agent, may be added for improving the fluidity of the solution, the releasability of the molded body, and the surface smoothness of the molded body. Examples of the plasticizer include phthalic acid esters, such as dibutyl phthalate and diisononyl phthalate; adipic acid esters, such as dioctyl adipate and diisononyl adipate; and trimellitic acid esters, such as trioctyl trimellitate. Examples of the release agent include polysiloxanes, such as dimethylpolysiloxane, methylphenyl siloxane, and methylhydrogen siloxane; and fluorine compounds.

For dispersing the surface-treated titanium oxide fine particles in a polyol, a stirrer or mixer may be used. The stirrer or mixer may be, but is not limited to, a mechanical or magnetic stirrer using shear force generated by rotation of the impeller or the stirring bar, or a rotation-revolution mixer using vortical upper and lower convections generated by rotation and revolution.

### Manufacturing Process of Simulated Biological Material for Photoacoustic Diagnostics

The simulated biological material of the present embodiment may be manufactured through the following steps (i) to (iv). For the process using a polyol as the dispersion medium, only Steps (i) and (ii) may be performed and the other steps may be omitted.

(i) Adding titanium oxide fine particles surface-treated with a polysiloxane having a Si—H partial structure to a polyol

(ii) Preparing a dispersion liquid containing the titanium oxide fine particles uniformly dispersed in the polyol by mixing and stirring the titanium oxide fine particles and the polyol

(iii) Preparing a curable composition containing the titanium oxide fine particles uniformly dispersed in the polyol by adding a polyisocyanate, and optionally additives, such as a catalyst, a plasticizer, and a release agent, to the dispersion liquid and stirring the dispersion liquid

(iv) forming a urethane resin molded body having a predetermined size by injecting the curable composition to a mold and allowing the polyol to react with the polyisocyanate optionally with heating

In the step of (iv), that is, in the step of molding for forming the simulated biological material, the curable composition may be subjected to degassing treatment to remove very small foams from the dispersion liquid or curable composition by pressure reduction or ultrasonic irradiation optionally with heating.

### Evaluation of Simulated Biological Material

The simulated biological material is evaluated in terms of the following (1) and (2):

(1) Dispersibility: the state of dispersion of the polysiloxane surface-treated titanium oxide fine particles in the dispersion liquid (polyol or urethane resin)

(2) Stability: the changes with time of the state of dispersion of the polysiloxane surface-treated titanium oxide fine particles in the dispersion liquid (polyol or urethane resin)
The dispersibility and stability of the dispersion may be estimated from the difference between the turbidities measured at an upper portion and a lower portion of the curable composition or the polymer composite material produce by curing the curable composition. More specifically, the smaller the difference, the better the dispersion of the titanium oxide fine particles; the larger the difference, the worse the dispersion. More specifically, the smaller the difference, the better the stability of the titanium oxide fine particles; the larger the difference, the worse the stability. When the difference in turbidity between the upper portion and the lower portion is within 1%, it is considered that the titanium oxide fine particles in the dispersion (curable composition or polymer composite material) are substantially uniformly dispersed, and that the dispersion state will be maintained even after a predetermined time (for example, several days) has passed.

For measuring the turbidity of a medium, for example, a sample placed in a 1 mm thick glass cell may be subjected to measurement at room temperature with a haze meter HZ-V3 (adaptable to JIS K 7105, JIS K 7136 and JIS K 7163, manufactured by Suga Test Instruments).

### EXAMPLES

The above-described embodiment will be further described in detail with reference to Examples, but is not limited to the examples.

### Example 1

The following materials were used in the Examples.
Titanium oxide fine particle: rutile-type titanium oxide fine particles surface-treated with methylhydrogen polysiloxane (SJR-405S, particle size: 210 nm, produced by Tayca)
Polyol: ethylene glycol-propylene glycol copolymer (number average molecular weight: 7000, hydroxy group equivalent weight: 3117 g/mol)

First, 100 g of the polyol was placed in a 300 mL transparent glass vessel, and 0.10 g of the titanium oxide fine particles were added to the vessel. Then, the materials were mixed and stirred with a mechanical stirrer equipped with an impeller of 50 mm in diameter at a rotation speed of about 200 rpm for 2 hours to prepare a dispersion liquid containing the titanium oxide fine particles (about 0.1% by weight) in the polyol. Subsequently, samples of the dispersion liquid immediately after the preparation was taken from an upper portion (at a depth of 1 cm to 2 cm from the surface of the dispersion) and a lower portion (at a height of 1 cm to 2 cm from the bottom of the vessel) with a pipette, and the samples were each placed in a 1 mm thick glass cell. Then, the turbidities of the samples of the dispersion liquid were measured with a haze meter. In addition, after the dispersion liquid was allowed to stand at room temperature for 5 days, samples of the dispersion liquid were further taken from an upper portion and a lower portion of the dispersion liquid with a pipette, and the turbidities of the samples were measured in the same manner as above. The results are shown in Table 1.

In the present Example, the difference in turbidity between the upper portion and the lower portion of the dispersion liquid was within 1% in either case of measurement immediately after preparation or after storage for 5 days. These results suggest that the titanium oxide fine particles were uniformly present throughout the dispersion liquid in either case immediately after preparation or after storage for 5 days. Also, no sediment of titanium oxide fine particles was observed on the bottom of the dispersion liquid vessel.

### Example 2

A dispersion liquid containing titanium oxide fine particles (about 0.2% by weight) in the polyol was prepared in the same manner as in Example 1, except that titanium oxide fine particles were added in a proportion of 0.20 g relative to 100 g of the polyol. Samples of the dispersion liquid were taken from an upper portion and a lower portion of the dispersion liquid and were subjected to turbidity measurement in the same manner as in Example 1. As shown in Table 1, the difference in turbidity between the upper portion and the lower portion of the dispersion liquid was within 1% in either case of measurement immediately after preparation or after storage for 5 days. It was thus confirmed that the titanium oxide fine particles were uniformly present throughout the dispersion liquid in either case immediately after preparation or after storage for 5 days. Also, no sediment of titanium oxide fine particles was observed on the bottom of the dispersion liquid vessel.

### Example 3

Rutile-type titanium oxide fine particles surface-treated with methylhydrogenpolysiloxane (MT-500SAS, particle size: 35 nm, produced by Tayca) were used instead of the titanium oxide fine particles used in Example 1. Except for this, a dispersion liquid containing titanium oxide fine particles (about 0.1% by weight) in the polyol was prepared in the same manner as in Example 1. Samples of the dispersion liquid were taken from an upper portion and a lower portion of the dispersion liquid and were subjected to turbidity measurement in the same manner as in Example 1. As shown in Table 1, the difference in turbidity between the upper portion and the lower portion was within 1% in either case of measurement immediately after preparation or after storage for 5 days. It was thus confirmed that the titanium oxide fine particles were uniformly present throughout the dispersion liquid in either case immediately after preparation or after storage for 5 days. Also, no sediment of titanium oxide fine particles was observed on the bottom of the dispersion liquid vessel.

### Example 4

A dispersion liquid containing titanium oxide fine particles (about 0.3% by weight) in the polyol was prepared in the same manner as in Example 3, except that titanium oxide fine particles were added in a proportion of 0.30 g relative to 100 g of the polyol. Samples of the dispersion liquid were taken from an upper portion and a lower side of the dispersion liquid and were subjected to turbidity measurement in the same manner as in Example 1. As shown in Table 1, the difference in turbidity between the upper portion and the lower portion was within 1% in either case of measurement immediately after preparation or after storage for 5 days. It was thus confirmed that the titanium oxide fine particles were uniformly present throughout the dispersion liquid in either case immediately after preparation or after storage for 5 days. Also, no sediment of titanium oxide fine particles was observed on the bottom of the dispersion liquid vessel.

### Example 5

A dispersion liquid containing titanium oxide fine particles (about 0.5% by weight) in the polyol was prepared in the same manner as in Example 3, except that titanium oxide fine particles were added in a proportion of 0.50 g relative to 100 g of polyol. Samples of the dispersion liquid were taken from an upper portion and a lower portion of the dispersion liquid and were subjected to turbidity measurement in the same manner as in Example 1. As shown in Table 1, the difference in turbidity between the upper portion and the lower portion was within 1% in either case of measurement immediately after preparation or after storage for 5 days. It was thus confirmed that the titanium oxide fine particles were uniformly present throughout the dispersion liquid in either case immediately after preparation or after storage for 5 days. Also, no sediment of titanium oxide fine particles was observed on the bottom of the dispersion liquid vessel.

### Example 6

Polytetramethylene glycol (number average molecular weight: 2000, hydroxy group equivalent weight: 988 g/mol) was used instead of the polyol used in Example 1, and 20 g of diisononyl phthalate (plasticizer) was added to impart a fluidity. Except for this, a dispersion liquid containing titanium oxide fine particles (about 0.08% by weight) in a polyol was prepared in the same manner as in Example 1. Samples of the dispersion liquid were taken from an upper portion and a lower portion of the dispersion liquid and were subjected to turbidity measurement in the same manner as in Example 1. As shown in Table 1, the difference in turbidity between the upper portion and the lower portion was within 1% in either case of measurement immediately after preparation or after storage for 5 days. It was thus confirmed that the titanium oxide fine particles were uniformly present throughout the dispersion liquid in either case immediately after preparation or after storage for 5 days. Also, no sediment of titanium oxide fine particles was observed on the bottom of the dispersion liquid vessel.

### Comparative Example 1

Rutile-type titanium oxide fine particles not surface-treated with any polysiloxane (JR-405, particle size: 210 nm, produced by Tayca) were used instead of the titanium oxide fine particles used in Example 1. Except for this, a dispersion liquid containing the titanium oxide fine particles (about 0.1% by weight) in the polyol was prepared. Samples of the dispersion liquid were taken from an upper portion and a lower portion of the dispersion liquid and were subjected to turbidity measurement in the same manner as in Example 1. As shown in Table 1, the difference in turbidity between the upper portion and the lower portion was large (turbidity at the upper portion <turbidity at the lower portion) immediately after preparation, and increased further during storage. These results suggests that the titanium oxide fine particles were present in a nonuniform state in the dispersion liquid with different concentrations between the upper portion and the lower portion (concentration at the upper portion <concentration at the lower portion). In addition, a sediment of the titanium oxide fine particles was observed on the bottom of the dispersion liquid vessel immediately after preparation and increased further in amount during storage.

### Comparative Example 2

To the dispersion liquid prepared in Comparative Example 1, 0.020 g of a polysiloxane (methylphenylpolysiloxane KF-968, produced by Shin-Etsu Chemical) was further added as the dispersant of the titanium oxide fine particles. Except for this, a dispersion liquid containing the titanium oxide fine particles (about 0.1% by weight) in the polyol was prepared. Samples of the dispersion liquid were taken from an upper portion and a lower portion of the dispersion liquid and were subjected to turbidity measurement in the same manner as in Comparative Example 1. As shown in Table 1, in the present Comparative Example, the dispersibility and stability were better than those in Comparative Example 1, but the difference in turbidity between the upper portion and the lower portion was large (turbidity at the upper portion <turbidity at the lower portion) immediately after preparation, and increased further during storage. Also, a sediment of the titanium oxide fine particles was observed on the bottom of the dispersion liquid vessel immediately after preparation and increased further in amount during storage.

### Comparative Example 3

Rutile-type titanium oxide fine particles surface-treated with hexamethyldisilazane (JRR-405H, particle size: 210 nm, produced by Tayca) were used instead of the titanium oxide fine particles used in Comparative Example 1. Except for this, a dispersion liquid containing the titanium oxide fine particles (about 0.1% by weight) in the polyol was prepared. Samples of the dispersion liquid were taken from an upper portion and a lower portion of the dispersion liquid and were subjected to turbidity measurement in the same manner as in Comparative Example 1. As shown in Table 1, in the present Comparative Example, the dispersibility and stability were better than those in Comparative Examples 1 and 2, but the difference in turbidity between the upper portion and the lower portion was large (turbidity at the upper portion <turbidity at the lower portion) immediately after preparation, and increased after being allowed to stand. Also, a sediment of the titanium oxide fine particles was observed on the bottom of the dispersion liquid vessel immediately after preparation and increased in amount after being allowed to stand.

### Comparative Example 4

Untreated rutile type titanium oxide fine particles (MT-500SA, particle size: 35 nm, produced by Tayca) was used instead of the titanium oxide fine particles used in Example 1. Except for this, a dispersion liquid containing the titanium oxide fine particles (about 0.1% by weight) in the polyol was prepared. Samples of the dispersion liquid were taken from an upper portion and a lower portion of the dispersion liquid and were subjected to turbidity measurement in the same manner as in Example 1. As shown in Table 1, the difference in turbidity between the upper portion and the lower portion was large (turbidity at the upper portion <turbidity at the lower portion) immediately after preparation, and increased after being allowed to stand. Also, a sediment of the titanium oxide fine particles was observed on the bottom of the dispersion liquid vessel immediately after preparation and increased further in amount during storage.

TABLE 1

| | Titanium oxide | | | | Difference in turbidity | | |
|---|---|---|---|---|---|---|---|
| | Content | Particle | Surface | | Immediately | After 5 | |
| | (% by | size | treatment | | after | days | |
| | weight) | (nm) | material | Polyol | preparation | storage | Sediment |
| Example 1 | 0.1 | 210 | Methylhydrogen | Ethylene glycol/ | 0.5 | 0.7 | None |
| | | | polysiloxane | propylene glycol | | | |
| | | | | copolymer | | | |
| Example 2 | 0.2 | 210 | Methylhydrogen | Ethylene glycol/ | 0.6 | 0.8 | None |
| | | | polysiloxane | propylene glycol | | | |
| | | | | copolymer | | | |
| Example 3 | 0.1 | 35 | Methylhydrogen | Ethylene glycol/ | 0.3 | 0.7 | None |
| | | | polysiloxane | propylene glycol | | | |
| | | | | copolymer | | | |
| Example 4 | 0.3 | 35 | Methylhydrogen | Ethylene glycol/ | 0.3 | 0.2 | None |
| | | | polysiloxane | propylene glycol | | | |
| | | | | copolymer | | | |
| Example 5 | 0.5 | 35 | Methylhydrogen | Ethylene glycol/ | 0.4 | 0.4 | None |
| | | | polysiloxane | propylene glycol | | | |
| | | | | copolymer | | | |
| Example 6 | 0.1 | 210 | Methylhydrogen | Polytetramethylene | 0.7 | 0.8 | None |
| | | | polysiloxane | glycol | | | |
| Comparative | 0.1 | 210 | — | Ethylene glycol/ | 15.2 | 22.3 | Observed |
| Example 1 | | | | propylene glycol | | | |
| | | | | copolymer | | | |
| Comparative | 0.1 | 210 | Additive (Methylphenyl | Ethylene glycol/ | 4.0 | 16.5 | Observed |
| Example 2 | | | polysiloxane) | propylene glycol | | | |
| | | | | copolymer | | | |
| Comparative | 0.1 | 210 | Hexamethyldisilazane | Ethylene glycol/ | 2.6 | 4.9 | Observed |
| Example 3 | | | | propylene glycol | | | |
| | | | | copolymer | | | |
| Comparative | 0.1 | 35 | — | Ethylene glycol/ | 6.7 | 11.0 | Observed |
| Example 4 | | | | propylene glycol | | | |
| | | | | copolymer | | | |

### Example 7

First, the same dispersion liquid as in Example 1 was prepared in the same manner. This dispersion liquid was allowed to stand at room temperature for 3 days. Then, samples of the dispersion liquid was taken from an upper portion (at a depth of 1 cm to 2 cm from the surface of the dispersion liquid) and a lower portion (at a height of 1 cm to 2 cm from the bottom of the vessel) of the dispersion liquid with a pipette, and a polyisocyanate compound (hexamethylene diisocyanate trimer) was added to the samples of the dispersion liquid in a proportion of 0.5 g relative to 10 g of the sample. Subsequently, each sample of the dispersion liquid was slowly stirred by hand to yield a curable composition. After the curable composition was placed in a 1 mm thick glass cell and allowed to stand overnight, the turbidity of the resulting cured product, or polymer composite material, was measured. As shown in Table 2, the difference in turbidity between the upper portion and the lower portion was within 1% even after storage for 3 days. This result suggests that the titanium oxide fine particles were uniformly present throughout the cured material.

### Example 8

The same dispersion liquid as in Example 2 was prepared in the same manner. In the same manner as in Example 7, samples of this dispersion liquid were taken from an upper portion and a lower portion, and curable compositions were prepared using the samples of the dispersion liquid. Then, the turbidities of the resulting cured products, or polymer composite materials, were measured. As shown in Table 2, the difference in turbidity between the upper portion and the lower portion was within 1% even after storage for 3 days. This result suggests that the titanium oxide fine particles were uniformly present throughout the cured material.

### Comparative Example 5

The same dispersion liquid as in Comparative Example 1 was prepared in the same manner. In the same manner as in Example 7, samples of this dispersion liquid were taken from an upper portion and a lower portion, and curable compositions were prepared using the samples of the dispersion liquid. Then, the turbidities of the resulting cured products, or polymer composite materials, were measured. As shown in Table 2, the difference in turbidity between the upper portion and the lower portion was large. This result suggests that the titanium oxide fine particles were nonuniformly present in the cured material.

### Comparative Example 6

The same dispersion liquid as in Comparative Example 2 was prepared in the same manner. In the same manner as in Example 7, samples of this dispersion liquid were taken from an upper portion and a lower portion, and curable compositions were prepared using the samples of the dispersion liquid. Then, the turbidities of the resulting cured products, or polymer composite materials, were measured. As shown in Table 2, the difference in turbidity between the upper portion and the lower portion was large. This result suggests that the titanium oxide fine particles were nonuniformly present in the cured material.

TABLE 2

| | Titanium oxide | | | | | Difference in | |
|---|---|---|---|---|---|---|---|
| | Content | Particle | Surface | | | turbidity | |
| | (% by | size | treatment | | | (after 3 days | |
| | weight) | (nm) | material | Polyol | Polyisocyanate | storage) | Nonuniformity⁽*⁾ |
| Example 7 | 0.1 | 210 | Methylhydrogen | Ethylene | Isocyanurate- | 0.7 | None |
| | | | polysiloxane | glycol/ | modified | | |
| | | | | propylene | isocyanate | | |
| | | | | glycol | | | |
| | | | | copolymer | | | |
| Example 8 | 0.2 | 210 | Methylhydrogen | Ethylene | Isocyanurate- | 0.8 | None |
| | | | polysiloxane | glycol/ | modified | | |
| | | | | propylene | isocyanate | | |
| | | | | glycol | | | |
| | | | | copolymer | | | |
| Comparative | 0.1 | 210 | — | Ethylene | Isocyanurate- | 21.6 | Observed |
| Example 5 | | | | glycol/ | modified | | |
| | | | | propylene | isocyanate | | |
| | | | | glycol | | | |
| | | | | copolymer | | | |
| Comparative | 0.1 | 210 | Additive | Ethylene | Isocyanurate- | 18.9 | Observed |
| Example 6 | | | (Methylphenyl | glycol/ | modified | | |
| | | | polysiloxane) | propylene | isocyanate | | |
| | | | | glycol | | | |
| | | | | copolymer | | | |

Note ⁽*⁾:
None for difference within 1.0%; observed for difference of 1.0% or more

In the materials prepared in the above-described Examples, that is, in the urethane resin containing titanium oxide fine particles or the liquid material containing titanium oxide fine particles in a polyol that is a precursor of the polyurethane, the titanium oxide fine particles are surface-treated with a polysiloxane having a Si—H partial structure. Consequently, the titanium oxide fine particles exhibited superior dispersibility and stability to the titanium oxide fine particles used in the Comparative Examples. Accordingly, the materials prepared in the Examples can be used as a simulated biological material having stable light scattering characteristics with high repeatability for photoacoustic diagnostic apparatuses.

The materials of the Examples can be produced using a known mixer or stirrer. Thus, a simulated biological material having stable light scattering characteristics with high repeatability can be produced for photoacoustic diagnostic apparatuses by the method used in the Examples.

Solubility parameter (SP value) can be a reason why titanium oxide fine particles surface-treated with a polysiloxane as in the embodiments of the application exhibit good dispersibility and stability in a medium (urethane resin or polyol). For example, the polysiloxane disclosed in Japanese Patent No. 3295685 has an SP value of 7.4 to 9.9, close to the SP value (8.6 to 10.9) of the polyol disclosed in Japanese Patent Laid-Open No. 8-120041. In such an instance, the polysiloxane and the polyol have good compatibility. Another possible reason is that the steric hindrance derived from the polysiloxane at the surfaces of the titanium oxide fine particles suppresses the reaggregation of the titanium oxide fine particles.

The material according to an embodiment of the application can be used as a simulated biological material for quality control and calibration of photoacoustic diagnostic apparatuses.

The simulated biological material for photoacoustic diagnostic apparatuses has stable light scattering characteristics with high repeatability, and the method according to an embodiment produces such a simulated biological material.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-095155, filed May 2, 2014, which is hereby incorporated by reference herein in its entirety.

What is claimed is:

1. A simulated biological material for photoacoustic diagnostic apparatuses, the material comprising:
a polyol; and
titanium oxide fine particles in the polyol, the titanium oxide fine particles being surface-treated with a polysiloxane having a Si—H partial structure.

2. A simulated biological material for photoacoustic diagnostic apparatuses, the material comprising:
a urethane resin that is a cured material produced from a polyol and a polyisocyanate, and
titanium oxide fine particles in the urethane resin, the titanium oxide fine particles being surface-treated with a polysiloxane having a Si—H partial structure.

3. The simulated biological material according to claim 1, wherein the polysiloxane is methylhydrogenpolysiloxane.

4. The simulated biological material according to claim 1, wherein the content of the titanium oxide fine particles is in the range of 0.05% by weight to 0.50% by weight relative to the total weight of the constituents of the simulated biological material.

5. The simulated biological material according to claim 1, wherein the titanium oxide fine particles have particle sizes in the range of 10 nm to 300 nm.

6. The simulated biological material according to claim 2, wherein the polysiloxane is a methylhydrogenpolysiloxane.

7. The simulated biological material according to claim 2, wherein the content of the titanium oxide fine particles is in the range of 0.05% by weight to 0.50% by weight relative to the total weight of the constituents of the simulated biological material.

8. The simulated biological material according to claim 2, wherein the titanium oxide fine particles have particle sizes in the range of 10 nm to 300 nm.

9. A method for manufacturing a simulated biological material for photoacoustic diagnostic apparatuses, the method comprising:
adding titanium oxide fine particles surface-treated with a polysiloxane having a Si—H partial structure to a polyol; and
preparing a dispersion liquid by mixing and stirring the titanium oxide fine particles and the polyol so that the titanium oxide fine particles are uniformly dispersed in the polyol.

10. A method for manufacturing a simulated biological material for photoacoustic diagnostic apparatuses, the method comprising:
adding titanium oxide fine particles surface-treated with a polysiloxane having a Si—H partial structure to a polyol;
preparing a dispersion liquid by mixing and stirring the titanium oxide fine particles and the polyol so that the titanium oxide fine particles are uniformly dispersed in the polyol;
preparing a curable composition containing the titanium oxide fine particles uniformly dispersed therein by adding a polyisocyanate to the dispersion liquid, and mixing and stirring the polyisocyanate and the dispersion liquid; and
producing a urethane resin containing the titanium oxide fine particles uniformly dispersed therein by injecting the curable composition in a mold, and allowing the polyol to react with the polyisocyanate.
